(19) United States
(12) Patent Application Publication
(10) Pub. No.: US 2003/0139638 A1
(43) Pub. Date: Jul. 24, 2003

(54) Continuous ecological inertization process of halogenated organic materials by metallurgy reactor thermo-destruction, recovering thermal energy from the combustion of thermo-destruction gases

(76) Inventor: Maria Ilaria Pistelli, Rome (IT)

Correspondence Address: BROWDY AND NEIMARK, P.L.L.C., 624 NINTH STREET, NW, SUITE 300, WASHINGTON, DC, 20001-5303, US

(21) Appl. No.: 10/168,340

(22) PCT Filed: Dec. 20, 2000
(86) PCT No.: PCT/IT00/00536

(30) Foreign Application Priority Data
Dec. 21, 1999 (IT) RM99A000780

(51) Int. Cl. A62D 3/00

(52) U.S. Cl. 588/206

(57) ABSTRACT

Continuous ecological inertization process of halogenated organic materials by metallurgy reactor thermo-destruction, comprising the steps of: introducing sideways in a lower area of the reactor off from the bottom thereof, via a first injection level, a mixture containing said halogenated organic materials, optional additives, fuels and carrier gases of the mixture, the quantity of lime added as additive being at least stoichiometric with respect to the quantity of halogenated organic material introduced; introducing sideways in a lower area of the reactor or from the bottom thereof, optionally via a second injection level, comburent; extracting, from a scavenging area, inert iron metallurgy slag in which compounds containing halogens, optionally to be recovered, are dissolved; recovering thermal energy from combustion of thermodestruction flue gases. The figure shows the sectional side view of an AOD (Argon Oxygen Decarburization) stainless steel converter, in which a specific embodiment of the process according to the invention is carried out.

### DESCRIPTION

The present invention relates to an ecological process for the continuous thermo-destruction, with chemical-physical reactions in the inside of a metallurgy reactor, of organic materials containing halogens, in particular chlorine, from which energy and non-hazardous controlled composition products are to be recovered.

More precisely the subject-matter of the present invention is a continuous ecological inertization process, by chemical-physical reactions in the inside of a metallurgy reactor, of organic materials containing halogens, in particular chlorine, in a solid, liquid and gaseous form, in order to attain non-hazardous controlled composition products outletted from the reactor itself

In fact, the process subject of the present invention is an ecological inertization process of halogenated organic materials by metallurgy reactor thermo-destruction thereof, comprising the steps of:

introducing sideways in a lower area of the reactor or from the bottom thereof, via a first injection level, a mixture containing said halogenated organic materials, lime, optional additives, fuels and carrier gases of the mixture, the quantity of lime in the reactor being at least stoichiometric with respect to the quantity of halogenated organic material charged therein;

introducing sideways in a lower area of the reactor or from the bottom thereof, optionally via a second injection level, comburent;

extracting from a scavenging area inert iron metallurgy slag in which halogenated compounds, optionally to be recovered, are dissolved;

recovering thermal energy from combustion of thermodestruction flue gases.

The introduction in the lower area of the reactor of a mixture containing halogenated organic materials, in particular chlorine, to be thermo-destroyed, fuel, optionally at least a fraction of comburent, optional additives and carrier gases of the mixture, takes place sideways to the tuyeres level in the radial direction, by a plurality of inlets, optionally on different levels or from the bottom.

In an embodiment of the present invention, the mixture of organic materials to be transformed, the fuel, a fraction of the comburent, optional inoculants and additives and carrier gases of the mixture, are introduced into the reactor corewise horizontally or slantingly with respect to a horizontal plane injection, and, concomitantly, the remaining fraction of comburent is introduced by injectors or by a duct coaxial to the mixture injection duct.

The material to be thermo-destroyed may have a granulometry lower than 8 mm. The granulometry of the fuel and of the additives may be lower than 8 mm, preferably lower than 3 mm.

The introduction rate of the comburent in the lower area of the reactor is lower than 40 m/s, being optionally such as to allow the individual jets to intersect thereamong, and anyhow such as to allow effective reaction kinetics.

The inside pressure of the reactor may range from 1 to 4 bar.

The halogenated organic materials to be inertized by thermo-destruction, are introduced in the reactor, i.e., in the area with the hot metal bath or a coke column, via a plurality of nozzles, and optionally carried by a carrier gas, concomitantly and jointly to the additives (like, e.g., calcium and magnesium carbonate or oxides), the fuel (such as coal dust, fuel oil, natural gas or binary or tertiary mixtures thereof) and to the comburent (like air, oxygen or mixture thereof).

In particular, the organic materials at issue are the chlorinated ones, like polychlorinated biphenyl (also known as polychlorobiphenyl; PCB), polyethylene chloride, and polyvinyl chloride (PVC). Also the use of FLUFF, a complex mix of materials, containing halogenated organic material (due to the presence of Cl atoms from the plastomeric and elastomeric fractions, and of F atoms from the latter) reclaimed from vehicle scrapping after removal of metallic fractions and crushing, was found to be satisfactory.

The material introduced in the reactor meets an elevated temperature environment with carbon monoxide generated from the incomplete combustion of the fuel with the comburent gas.

The presence of CO and CaO in the slag results in the inclusion of noxious elements (like, e.g., halogens) therein, essentially as calcium salts.

The direct gasification under reducing conditions of the organic materials provides CO; the process gas thus generated may be useful to provide energy from the combustion thereof, to sustain the thermal state of the reactor.

In view of the desirable aims, the processes which may be carried out according to the present invention require, in some metallurgy reactors, high chemical kinetics, which also depend on a suitable homogeneity of the bath (consisting of metallic phase and slag phase), and efficient heat exchanges. These aims may also be attained by bath agitation.

The bath agitation, when required, is essentially carried out by the injected materials, and optionally by bottom-blown gases.

A further subject of the present invention is the inertized products yielded by the heretodisclosed process.

So far, only a general disclosure of the present invention is hereby given. With the aid of the examples hereinafter and of the single annexed figure, a more detailed description will now be given of its embodiments, aimed at making better understood objects, features, advantages and operation modes thereof.

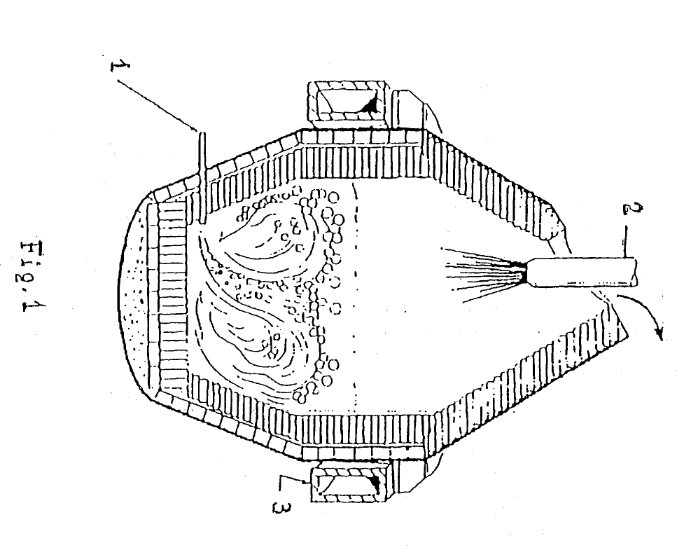

FIG. 1 is the sectional side view of a stainless steelmaking AOD (Argon Oxygen Decarburization)--converter, inside which an embodiment of the process according to the invention is carried out.

### EXAMPLE 1

### Injection of Reactive Mixture in Blast Furnace

In this example the aboveidentified unit is used, concomitantly to the production of iron cast, for the treatment of solid or liquid materials containing C, H and Cl. The object is that of using the apparatus for the thermo-destruction of materials containing PCB (polychlorinated biphenyl, also known as polychlorobiphenyl), attaining CO, hydrogen and chlorides of alkali earth metals and concomitantly avoiding the formation of noxious chlorinated gases, like, e.g., phosgene, dioxin and polychlorofuranes.

The introduced materials and the flow rates thereof (kg/h for the solids, Nm³/h for the gases) are reported in Table 1.1

TABLE 1.1

| | | |
|---|---|---|
| PCB-containing materials | 1200 | kg/h |
| PCB-injected Fuel | 2800 | kg/h coal dust |
| Comburent | 11000 | Nm³/h O₂ |
| PCB-injected additives | 32 | kg/h CaO |
| Carrier gases | 400 | Nm³/h N |

The PCB-containing mixture is injected with inert gas in the tuyeres area, concomitantly and jointly to the coal dust, to the oxygen and to the calcium oxide. Peripherally to this area, at the bosh, the molten slag-metal emulsion which actively contributes to the reaction between the additives and the chlorinated substances flows cruciblewise.

The injection area has a >1600° C. temperature.

The binary (%CaO/%SiO₂) basicity of the blast furnace preferably ranges from 1 to 1.5, the optimal values for the running thereof.

The PCB-fuel-slag additives mixture, when injected in the tuyeres, meets a high-temperature environment, which is highly reducing due to the presence of the gases generated in the gasification of the fuel and by the residual unburned fuel.

The presence of CaO in the charge and the highly reducing environment results in the in-slag inclusion of the halogens as calcium salts.

The joint injection of fuel and comburent provides the energy transfer required to the carrying out of the process and contributes to the maintenance of the thermal condition of the reactor.

This operation mode allows to yield from the injected materials (PCB, fuel, comburent, additives) a slag phase and a gaseous phase, which, by virtue of the chloride pickup by the slag, essentially consists of permanent gases (like N₂, CO, CO₂ and H₂), and steam. The resulting aeriform mix is also free from hazardous compounds (like SOx, NOx) since the sulphur is included in the slag as CaS and the nitrogen is not oxidized to NOx by virtue of the highly reducing environment.

The process gas continually outletted from the reactor is delivered to regeneration plants for recovering the thermal heat contained therein.

The materials outletted from the apparatus are reported in Table 1.2.

TABLE 1.2

| | | |
|---|---|---|
| Gas outletted from reactor | 60000 | Nm³/h |
| Tapped iron | 1000 | t/d |
| Tapped slag | 300 | t/d |

### EXAMPLE 2

### Injection of Reactive Mixture in OBM Converter

In this example the features of the process subject of the present invention, using an OBM (Oxygen Bodenblasen Maxhütte) converter, are disclosed in the following table 2.1, in which the introduced materials and the flow rates (kg/h for the solids, Nm³/h for the gases) thereof are reported.

TABLE 2.1

| | | |
|---|---|---|
| PVC | 4500 | kg/h |
| Comburent | 60000 | Nm³/h O₂ |
| Additives | 4000 | Kg/h CaO |
| Carrier gases | 450 | Nm³/h N₂ |

The example relates to the use of an OBM converter for the thermo-destruction of the polyvinyl chloride, PVC, (concomitantly to the steelmaking) aimed at attaining a CaCl-containing inertized slag.

Oxygen is injected through the bottom, by tuyeres made from concentric tubes transporting outerly hydrocarbon fluid in order to cool the site of injection of the oxygen into the molten metal phase. The PVC-containing reactive mixture is injected through the bottom using injectors habitually used to inject powdered lime.

The thermo-destruction of the PVC takes place inside the converter, wherein there usually is a basic slag in an environment allowing, on the one hand, to fix in the thermo-destruction of the PVC, and, on the other hand, to readily solubilize and inertize the products resulting from the thermo-destruction thereof.

The thermo-destruction, in presence of basic slag and with the addition of additives, provides the following advantages:

the tendency of the chlorine to react with the metal phase is hindered, thereby avoiding the resulting metallic phase losses,

The amounts of HCl or Cl in the process gas are remarkably abated, with the entailed ecological advantages,

no dioxins or polychlorofurane are formed,

the halogens are included in the slag as calcium salts.

The molten slag in emulsion with the molten metal bath will have at 1400° C. a <4 poise viscosity in order to provide an effective emulsioning with the metallic phase and therefore a high homogeneity of the reaction environment.

Furthermore, the composition of the slag should be such as to limit the wear of the reactor refractories. In case of C-bonded magnesia refractories, the percentage of magnesium oxide in the slag should be >8%.

The gasification of the PVC, injected concomitantly and jointly to the oxygen by the injectors, generates also energy.

Oftentimes, in order to maintain the thermal condition of the reactor this gas is partially post-combured by suitably injected comburent.

In the case, in order to implement a thermochemical homogeneity of the bath apt to ensure high reaction kinetics, inert gas (e.g., N₂) may be bottom-blown into the bath.

This operation mode allows to attain from the injected materials (PVC, comburent, additives).. a gaseous phase consisting of permanent gases (like N₂, CO, CO₂ and H₂) and steam, free, by virtue of the filtering action of the slag, from hazardous compounds like the chlorinated ones.

The process gas continually outletted from the reactor is delivered to regeneration plants.

The metallic phase and the slag are cyclically tapped from the reactor by opening the tap hole provided for the purpose.

The materials outletted from the apparatus are reported in Table 2.2.

TABLE 2.2

| | | |
|---|---|---|
| Fumes outletted from | 90000 | Nm³ |
| reactor | | |
| Metallic phase | 300 | t/casting |
| Slag | 30 | t/casting |

The quantities useful to define an appropriate carrying out of the process are reported, in terms of chemical reactions and heat exchange, in Table 2.3.

TABLE 2.3

| | |
|---|---|
| Specific molten bath | 0.5 |
| agitation power | kW/t metallic phase |
| Metallic phase/Slag | 0.1 |
| phase mass ratio in the | |
| reactor | |

### EXAMPLE 3

### Injection of Reactive Mixture in AOD Converter

The features of the process used according to the invention in this example are disclosed in the following Table 3.1, reporting the introduced materials and the flow rates (kg/h for the solids, m³ (STP)/h for the gases) thereof.

TABLE 3.1

| | | |
|---|---|---|
| PVC | 600 | kg/h |
| Primary comburent | 8000 | m³ (STP)/h O₂ |
| Additives | 500 | kg/h CaO |
| Carrier gases | 2700 | m³ (STP)/h Nₛ or Ar |

The example relates to the use of an AOD (Argon Oxygen Decarburization) converter shown in a side sectional view in FIG. 1, for the thermo-destruction (concomitant to the stainless steelmaking), during the first stage of the PVC decarburization (oxygen/inert gas ratio: 3:1) aimed at the production of a CaCl-containing inertized slag.

The oxygen is injected sideways, through tuyeres 1 made from concentric tubes outerly transporting the inert gas required both to favour the decarburization over the chrome oxidation and to cool the injection site of the oxygen in the molten metal phase. As it is known, additional oxygen and/or inert gas may be introduced with the lance 2. The PVC-containing reactive mixture is injected sideways, using the tuyeres 1.

The thermo-destruction of the PVC takes place inside the converter, in which there usually is a basic slag in an environment allowing, on the one hand, to fix in the slag as stable compounds the chlorine generated from the thermo-destruction of the PVC and, on the other hand, to readily solubilize and inertize the products yielded from the thermo-destruction of the latter.

The thermo-destruction in presence of basic slag and with the addition of additives allows to attain the same advantages highlighted in the previous example.

The molten slag in emulsion with the molten metal bath ensures, under the operative conditions of an AOD, an effective emulsion with the metallic phase and therefore a remarkable homogeneity of the reaction environment.

Normally, the slag composition is such as to limit the wear of the magnesia refractories lining the reactor.

The gasification of the PVC, injected through the tuyeres 1 concomitantly and jointly to the oxygen-inert gas mixture, generates also energy.

Oftentimes, for the maintenance of the thermal condition of the reactor, this gas is partially post-combured by suitably injected comburent.

The gases blown through the tuyeres implement the thermal and the chemical homogeneity of the bath which is apt to ensure high reaction kinetics.

This operation mode allows to attain from the injected materials (PVC, comburent, additives) a gaseous phase consisting of permanent gases (like N₂, CO, CO₂ and H₂) and of steam, free, by virtue of the straining action of the slag, from hazardous compounds like the chlorinated ones.

The process gas continually outletted from the reactor is delivered to the regeneration plants. The metallic phase and the slag are cyclically tapped from the reactor, tilting the latter by the tilting ring 3.

The materials outletted from the apparatus are indicated in Table 3.2.

TABLE 3.2

| | | |
|---|---|---|
| Fumes outletted from reactor | 90000 | Nm³/h |
| Metallic phase | 130 | t/casting |
| Slag | 13 | t/casting |

The quantities useful for defining an appropriate carrying out of the process, in terms of chemical reactions and of heat exchange, are reported in Table 3.3.

TABLE 3.3

| | |
|---|---|
| Specific molten bath | 0.5 |
| agitation power | kW/t metallic phase |
| Metallic phase/Slag | 0.1 |
| phase mass ratio in the | |
| reactor | |

1. A continuous ecological inertization process of halogenated organic materials by metallurgy reactor thermo-destruction thereof, comprising the steps of:
introducing sideways in a lower area of the reactor or from the bottom thereof, via a first injection level, a mixture containing said halogenated organic materials, lime, optional additives, fuels and carrier gases of the mixture, the quantity of lime added as additive being at least stoichiometric with respect to the quantity of halogenated organic material introduced;
charging sideways in a lower area of the reactor or from the bottom thereof, optionally via a second injection level, comburent;
extracting, from a scavenging area, inert iron metallurgy slag in which compounds containing halogens, optionally to be recovered, are dissolved;
recovering thermal energy from combustion of thermodestruction gases.

2. The process according to claim 1, wherein the introduction in the lower area of the reactor of said mixture takes place sideways to the tuyeres level.

3. The process according to claim 1, wherein the introduction of said mixture in the lower area of the reactor or from the bottom thereof takes place in presence of a molten metal/slag emulsion having a temperature greater than 1400° C.

4. The process according to any one of the preceding claims, wherein the height of the area, having a temperature greater than 1400° C., is greater than or equal to 1000 mm.

5. The process according to any one of the preceding claims, wherein the introduction in the lower area of the reactor of the mixture of halogenated organic materials, fuel, comburent, and optionally of additives and carrier gases, takes place in the radial direction, via a plurality of inlets optionally on different levels.

6. The process according to any one of the claims 1 to 2, wherein in the lower area of the reactor the halogenated organic material to be thermo-destroyed, the carrier gases, the fuel, a fraction of the comburent and optionally additives, are introduced corewise horizontally or slantingly with respect to a horizontal plane.

7. The process according to any one of the preceding claims, wherein the mixture containing the halogenated organic materials to be thermo-destroyed has a granulometry lower than 8 mm.

8. The process according to any one of the preceding claims, wherein the granulometry of the fuel and of the additives is lower than 8 mm, preferably lower than 3 mm.

9. The process according to any one of the preceding claims, wherein the introduction rate of the comburent in the lower area of the reactor is lower than 40 m/s and anyhow such as to allow the individual jets to intersect thereamong.

10. The process according to any one of the preceding claims, wherein the binary basicity index of the slag is greater than 1.

11. The process according to any one of the preceding claims, wherein the inside pressure of the reactor ranges from 1 to 4 bar.

12. The process according to any one of the preceding claims, wherein said mixture comprising halogenated organic materials to be thermo-destroyed comprises organic materials selected from the group comprising polychlorinated biphenyl (PCB), polyethylene chloride, polyvinyl chloride (PVC), FLUFF—a complex mix of materials—containing halogenated organic material, due to the presence of Cl and F atoms, reclaimed from vehicle scrapping after removal of metallic fractions and crushing, and combinations thereof.
